(19) United States
(12) Patent Application Publication
(10) Pub. No.: US 2021/0381309 A1
(43) Pub. Date: Dec. 9, 2021

(54) FRAME ASSEMBLY

(71) Applicant: Infinity Retractable Screens Pty Ltd, Currumbin Waters (AU)

(72) Inventors: Anthony Gerard ROBERTS, Currumbin Waters (AU); Aaron RODD, Currumbin Waters (AU)

(73) Assignee: Infinity Retractable Screens Pty Ltd, Currumbin Waters (AU)

(21) Appl. No.: 17/405,228

(22) Filed: Aug. 18, 2021

Related U.S. Application Data
(63) Continuation of application No. PCT/AU2020/050138, filed on Feb. 18, 2020.

(30) Foreign Application Priority Data
Feb. 18, 2019 (AU) 2019900511

(51) Int. Cl. E06B 9/58; E06B 9/17

(52) U.S. Cl. CPC E06B 9/58; E06B 2009/587; E06B 9/1703

(57) ABSTRACT

A retractable screen that is integrated within a wall cavity and fixed to an internal door frame. The screen has a base frame mounted to the support. The base frame comprises a lower elongate member a U shaped upper elongate member and two U shaped side elongate members each having an upper part and a lower part respectively fixed to the upper and lower elongate members. A lower guide track is mounted to the lower elongate member. An upper guide track assembly is mounted within the upper elongate member. The upper guide track assembly includes an elongate insert member with an upper guide track mounted therein and the elongate insert member is configured for insert installation into the upper elongate member. The side elongate members house a roller assembly for a screen.

### CROSS REFERENCE TO RELATED APPLICATIONS

This application claims priority benefit from International Application No. PCT/AU2020/050138 filed on Feb. 18, 2020, which claims priority from Australian Application No. 2019900511 filed on Feb. 18, 2019, each of which are incorporated herein by reference in their entireties.

### FIELD OF INVENTION

The present disclosure relates to a frame assembly for a retractable screen of the type having a flexible screen material that can be drawn off a roller within a housing and across an architectural opening.

### BACKGROUND OF THE INVENTION

Retractable screens that can be opened have found appeal with users due to their versatility in being able to be rolled away when not in use. This enables a wide and uninterrupted view when withdrawn. The present disclosure will be described with particular reference to an insect screen mesh. However, it will be appreciated that the disclosure may relate to other types of flexible screen material and no limitation is intended thereby.

Retractable screens can be mounted across any suitable architectural opening such as windows, doors, and between supports in outdoor areas such as pergolas, gazebos and the like. Retractable screens are generally insect screens. However, other types of screens such as solar screens, transparent vinyl screens or the like may also be retractable.

Retractable screens in general have a roller located within a housing, upon which the screen is rolled onto as the screen is closed and the screen is unrolled from when the screen is opened. The roller is usually biased towards the closed or rolled position. The housing is typically fixed in place at the top of a vertically opening screen or at the side of a horizontally opening screen. The screen extends between a housing and a moveable handle post or drawbar that is moveable between and open position towards the housing and a closed position away from the housing. Upper and lower, right or left guide tracks (for horizontally and vertically opening windows) are operatively engaged with the respective ends of the moveable handle post to guide movement of the post between open and closed positions.

Alternatively, the housing may be located within the moveable handle post, although this is not as preferred for larger screens.

Horizontally opening screens can pose problems that are not found with vertically opening screens. It is desirable that the screen presents a taught and neat appearance across the face of the screen and the screen and does not sag or buckle. With vertically opening screens, the weight of the screen applies tension in the vertical direction between the roller and the end of the screen, thereby preserving a taught appearance. The vertical side tracks on either side of the screen do not carry any weight and serve simply as a guide.

However, with horizontally opening screens, the roller does not carry the weight of the screen. For larger and heavier screens, that is screens larger than a conventional single doorway of about 1 m, the weight if the screen can cause sagging of the screen. Accordingly, the design of functional components for larger such as rollers, handle posts and upper guide tracks are generally designed to bear such weight.

It is important, especially for insect screens, that the edges of the screen are securely held in place such that there are no gaps through which insects may pass. Suitably, the longitudinal edges of the screens are retained within a channel in the respective guide tracks and the transverse edge is securely held along the length of the moveable handle post (or housing). This may also assist in providing a desirable taut and neat appearance across the face of the screen

In use, larger retractable screens may subjected to forces caused by the tautness of the screen such that the screen may pull from the guide tracks and become loose. This is undesirable for customers. Further, this can create gaps through which insects may pass. When closed, the screens may be subjected to winds that can cause the screen to “blow out” of the guide tracks. Again larger screens will be subject to greater forces created by winds. To avoid “blow out”, screen receiving channels in the guide tracks and/or the edges of the screen are arranged so that they are securely received therein. Generally, the upper and lower edges of the screen have a thickened edge, bead or zippered edge that is received within a longitudinal edge retaining part of the respective guide track.

The desirability for the screen to be securely held so as to resist “blow out” must be balanced with the ability of the longitudinal edges of the screen to be able to readily slide along the tracks during opening and closing.

Customers are demanding horizontally opening screens of increasing width to extend across open areas that are significantly wider than a standard doorway. Such larger areas have doors such as bi-fold doors, stacker doors and French doors. Such openings may have a span of 2 m to 4.5 m and up to 9 m for a double opening retractable screen. That is the width of the closed screen is greater than the height of the screen.

It will be appreciated that smaller vertically opening screens such as those as used for a single opening door do not have sufficient weight to cause such problems.

Retractable screens are conventionally installed by retrofitting to an existing door way. The lower guide track may be screwed directly to the door sill and the upper guide track is directly screwed to the front face of the door head. The roller and handle post assembly are fixed to the frame on one side of the door and the receiving post to the frame on the other side of the door.

A housing is generally mounted over the upper guide track to hide the guide track and the upper edges of the screen from view. The housings are generally available in a range of colour and finishes to match the doorway and general architecture of the building to which the screen is installed.

It will be appreciated that with retrofitting larger screen frames, careful adjustment and alignment is required.

Customers demand is not limited to wider screens but also screens that are more aesthetic and blend in further with the surrounding door frames. Customer needs however, need to be balanced with functionality including ease of operation, resistance to blow out and sagging and ease and efficiency of installation.

### SUMMARY OF THE INVENTION

The present disclosure is directed to a base frame, a retractable screen assembly comprising the base frame, a retractable screen system and method of installing the base frame and the retractable screen assembly method, which may in some aspects at least partially overcome at least one of the abovementioned disadvantages or provide the consumer with a useful or commercial choice.

In the present description and claims, the term “inner” refers to that side of the base frame, screen assembly, or a component that faces inwardly towards the internal wall cladding and internal living space. The term “outer” refers to that side of the base frame, screen assembly or a component thereof that in use faces the opposite direction, that is towards the exterior of the living space. The terms “upper” and “lower” refer to the respective orientations with respect to the a ceiling and floor or substrate surface when the base frame screen or screen assembly is installed.

In an embodiment there is disclosed an assembled base frame for mounting to a support, the base frame comprising; a lower elongate member having an upper mounting part; an upper elongate member and two side elongate members each having an upper part and a lower part respectively fixed to the upper and lower elongate members, wherein; the upper mounting part of the lower elongate member is configured for engaging a lower guide track of a retractable screen when the base frame is mounted to the support, the upper elongate member is configured to receive an upper elongate guide track of a retractable screen when the base frame is mounted to the support and one or both of the side elongate members are configured to receive a roller housing for a retractable screen.

The upper elongate member may have a U shaped profile with opposing side walls, each wall having inwardly extending engagement members for engagement with an upper guide track.

Each side elongate member may be an aluminium extrusion having a U shaped profile with a first side wall, a second side wall a web and an open side, such that each side wall has a free end remote from the web the free end of the one wall terminates in a rectangular channel and a longitudinal plastics block is received within the rectangular channel.

The lower elongate member may have a first side wall and a second side wall and the lower elongate member is fixed to a lower end of each side elongate member such that the first side wall is transvers to the rectangular channel of the elongate side member and at least one fastener extends through the rectangular channel and the plastics block contained therein and into the end of the first side wall of the lower elongate member.

In an embodiment, the base frame further comprises an end cap received within the lower end of each side elongate member, the end cap having a first side wall adjacent the first side wall of the side elongate member, a second side wall adjacent the second side wall of the side elongate member, a rear wall adjacent the web of the side elongate member and a front wall across the open side of the side elongate member

The end cap may comprises a tab extending from the front wall so as to seals the end of the rectangular channel.

The inner surface of one or both side walls of the side elongate member may include at least two longitudinal ribs and the one or both side walls of the end cap comprise at least one locating projection dimensioned to be received between two of the at least two longitudinal ribs.

The end cap may be fastened to the side elongate member by at least one fastener passing through the or each wall and through the at least one locating projection.

Suitably the faster is a screw or a permanent faster such as a rivet. The term permeant when referring to a fastener has the same meaning as understood by a person skilled in the mechanical construction arts, i.e. that of the fastener is removed, the joined parts may be subject to damage.

The end cap further may comprise a tab extending from the front wall and the tab is dimensioned to locate within the U channel of the lower elongate member.

The lower elongate member may be an aluminium extrusion that has a lower base part configured to be received in a recessed floor cavity.

The lower elongate member has a profile in which the lower base part includes a U channel section extending below the upper mounting part and in use the web of the U channel rests on the base of the recessed floor cavity.

The upper mounting part may comprise a first horizontal support arm extending away from one side of the U channel, a second horizontal support arm extending away from the other side of the U channel and each support arm member has a guide track engagement part.

In an embodiment there is disclosed an assembly comprising the base frame as disclosed herein mounted to a support.

The support may be a frame for a sliding door, a bi-fold door or a stacker door.

The assembly may be installed in an architectural opening in a building structure.

In the base frame comprises a cover removeably mounted to the upper mounting part of the lower elongate member.

A cover may also be removeably mounted to each side elongate member.

In an embodiment there is disclosed a retractable screen comprising the base frame as disclosed herein, a retractable roller assembly mounted in one or each side elongate member, an upper guide track mounted to the upper mounting member and a lower guide track mounted to the lower mounting member.

The upper guide track may be in the form of an upper guide track assembly comprising a guide track housing and an upper guide member mounted thereto, whereby the track housing is configured for mounting to the upper elongate member.

The upper elongate mounting member may have a U shaped profile and the guide track housing is configured as an elongate insert member for inserting into the U shaped upper elongate member

The elongate insert member may comprise a first side wall, a second side wall and an intermediate wall each connected by a cross member so as to define a first downward opening U channel between the first side wall and the intermediate wall and a second downward opening U channel defined between the second side wall and the intermediate wall and the upper guide track member is located within the first channel.

The side of walls of the upper elongate mounting member and the outer side of the walls of the elongate insert member may be configured for snap fit engagement when the elongate insert member is inserted into the U channel of the upper elongate member.

The elongate guide track is suitably mounted within the first channel by slidable insertion into the channel.

The elongate guide track may comprises an elongate body having a lower face with a longitudinal channel for receiving and retaining an upper edge of a retractable screen; a first substantially resilient wing and a second substantially resilient wing extending from respective first and second sides of the elongate body and each first and second wing comprises a proximal end towards the elongate body and a distal end and each wing is biased towards an open position in which the distal end of each wing is away from the body and is moveable against the bias to a retracted position in which each distal end of each first and second wing is towards the body.

In an embodiment there is disclosed a method of installing a retractable screen assembly, comprising providing the base frame as disclosed herein, mounting the base frame to a support and after the base frame has been mounted to the support, the steps of, in any order, mounting an upper guide track to the upper elongate member, mounting a lower guide track to the lower elongate member and mounting a retractable screen roller assembly to one or both of the side elongate members.

The support and base frame may be mounted within an internal wall cavity and wall covering is installed over the base frame and prior to the mounting of the upper guide track, the lower guide track.

In an embodiment, there is disclosed a method of installing the disclosed retractable screen assembly, comprising providing the disclosed support and base frame assembly, and the steps of, in any order, mounting an upper guide track to the upper elongate member, mounting a lower guide track to the lower elongate member and mounting a retractable screen roller assembly to one or both of the side elongate members.

In an embodiment, there is disclosed a kit for constructing the base frame s disclosed herein comprising a lower elongate member configured for mounting a lower elongate guide track for a retractable screen, an upper elongate member configured to receive an upper elongate guide track and two side elongate members having upper and lower parts respectively fixed to the upper and lower elongate members, wherein one or both of the side elongate members are configured to receive a roller housing for a retractable screen.

Suitably the members of the base frame are sized so as to have substantially the same width. This may allow the base frame to have a substantially uniform appearance. This has a number of advantages depending upon how the base frame is to be installed for example during a building construction or retrofitting.

An advantage of installation during building construction is that the base frame may be installed prior to the walls being clad. The wall cladding may then be placed over the base frame such that the side members and upper guide tracking mounting member are concealed behind the cladding.

After the base frame is installed, all the functional members of the screen assembly may be mounted or installed on the base frame at any suitable time. The functional members of the screen assembly are this members necessary for a retractable screen to function and includes a roller assembly with a roller and a flexible screen rolled thereon, an upper guide track for the roller screen and a lower guide track for the flexible screen.

It will be appreciated that such a method of installation is distinct from conventional flexible screen installation methods in which the upper guide track is fixed either directly or indirectly to a support at the time of installation of the full screen.

In some cases, it may be desirable to defer installation of the functional members of the screen for a period of time. For example, the base frame may be installed during construction of a dwelling. The buyer of the constructed dwelling then has the option of installing the screen at a later date, subject to preference and/or costs.

It will be appreciated that such after construction installation of the functional members of the screen may offer a number of advantages. First the retrofitted screen has the aesthetic advantages of a screen installed during construction. Second, the fitting of the functional members is much simpler than conventional retrofitting. For example, it is not necessary to correctly align the functional members. This is because the base frame parts are already aligned. When the upper guide track is mounted to the upper member the, guide track is automatically in alignment. The same applies to the lower guide track. Further, the use of fasteners such as screws is not required.

The lower elongate mounting member is configured for mounting a lower guide track. Suitably, the mounting member has an upper mounting part and the lower guide track has an engagement part for engagement with the mounting member.

The respective configurations of the upper mounting part and the engagement part may be any suitable configuration that enables the lower guide track to be mounted to the lower elongate mounting member after base frame installation.

An exemplary configuration is that described in co-applicants Australian patent application No 201726847, incorporated herein by reference.

The respective configurations of the upper elongate mounting member and upper guide track may be any suitable configuration that enables the upper guide track to be mounted to the upper elongate mounting member after base frame installation.

In one aspect, the upper guide track may be in the form of an upper guide track assembly comprising a track housing and an upper guide member mounter thereto, whereby the track housing is configured for mounting to the upper elongate mounting member.

After installation of the base frame, it will be appreciated that the lower elongate mounting member will be exposed. This may be unsightly, cause a trip hazard or be exposed to dust and other debris as a result of completion of construction. Thus in one aspect, it is preferable to provide an elongate cover member to at least partially cover the lower elongate mounting member.

The side elongate members are suitably U shaped extrusions that may accommodate a roller housing. Thus the side members have an open side. In one aspect, there is further proved a cover for mounting to the side elongate members.

In another aspect there is disclosed a method of installing a retractable screen assembly, comprising providing a base frame as disclosed herein, mounting the base frame to a support and after the base frame has been mounted to the support, the steps of, in any order, mounting an upper guide track to the upper elongate member, mounting a lower guide track to the lower elongate member and a retractable screen roller housing to one or both of the side elongate members.

Also disclosed herein is a kit for constructing a base frame as disclosed herein comprising a lower elongate member configured for mounting a lower elongate guide track for a retractable screen, an upper elongate member configured to receive an upper elongate guide track and two side elongate members having upper and lower parts respectively fixed to the upper and lower elongate members, wherein one or both of the side elongate members are configured to receive roller housing for a retractable screen.

Any of the features described herein can be combined in any combination with any one or more of the other features described herein within the scope of the disclosure.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of Invention in any way. The Detailed Description will make reference to a number of drawings as follows:

FIG. 1 is a schematic top plan view of a prior art retractable screen assembly, in accordance with an aspect of the present disclosure;

FIG. 2 is a schematic view of an assembled base frame as disclosed herein prior to mounting to a bi-fold or stacker door frame, in accordance with an aspect of the present disclosure;

FIG. 3 is a schematic exposed view of a lower corner part of a retractable screen assembly, in accordance with an aspect of the present disclosure;

FIG. 4 is a schematic exposed view of the upper corner part of a retractable screen assembly, in accordance with an aspect of the present disclosure;

FIG. 5 is a cross section of the extrusion that forms the side mounting members of the base frame as shown in FIG. 4, in accordance with an aspect of the present disclosure;

FIG. 6 is a cross section of an in filler block for inserting into a channel of the extrusion shown in FIG. 5, in accordance with an aspect of the present disclosure;

FIG. 7 is a cross section of the extrusion that forms the lower mounting member of the base frame as shown in FIG. 4, in accordance with an aspect of the present disclosure;

FIG. 8 is a cross section of the extrusion that forms the upper mounting member of the base frame as shown in FIG. 4, in accordance with an aspect of the present disclosure;

FIG. 9 is a schematic view of an open in line for assembly view of a lower end of a side member and an end cap as one step in the assembly of the base frame as shown in FIG. 4, in accordance with an aspect of the present disclosure;

FIG. 10 is a schematic view of the end of the side member with the end cap installed as a next step in the assembly of the base frame as shown in FIG. 4, in accordance with an aspect of the present disclosure;

FIG. 11 is a schematic view of one side of the upper end of the side member showing a next step of the assembly of the base frame as shown in FIG. 4, in accordance with an aspect of the present disclosure;

FIG. 12 is a schematic view of the other side of the upper end of the side member showing a next step of the assembly of the base frame as shown in FIG. 4, in accordance with an aspect of the present disclosure;

FIG. 13 is a schematic view showing joining of the upper part of one side member to the header in a next step of the assembly of the base frame as shown in FIG. 4, in accordance with an aspect of the present disclosure;

FIG. 14 is a schematic view showing joining of the lower part of one side member to the sill in a next step of the assembly of the base frame as shown in FIG. 4, in accordance with an aspect of the present disclosure;

FIG. 15 is a schematic showing a next step of the assembly of the base frame as shown in FIG. 4, in accordance with an aspect of the present disclosure;

FIG. 16 is a schematic exposed view of a lower corner part of the base frame as shown in FIG. 4 after mounting to the door frame, in accordance with an aspect of the present disclosure;

FIG. 17 is the same view as shown in FIG. 16 with a cover mounted to the lower mounting member and a cover mounted to the side member, in accordance with an aspect of the present disclosure;

FIG. 18 is a cross section view showing the extrusion forming the lower mounting member cover mounted to the lower mounting member, in accordance with an aspect of the present disclosure;

FIG. 19 is a cross section view of the extrusion forming the cover for the side member mounted to the side member, in accordance with an aspect of the present disclosure;

FIG. 20 is a detail of FIG. 1 showing the lower guide track, in accordance with an aspect of the present disclosure;

FIG. 21 is a schematic view of the upper corner of the installed assembly without covers or functional members, in accordance with an aspect of the present disclosure;

FIG. 22 is a cross section view of the insert for the upper mounting member, in accordance with an aspect of the present disclosure;

FIG. 23 is a cross section view of the upper mounting member and insert mounted therein, in accordance with an aspect of the present disclosure;

FIG. 24 is a cross section view of the insert with an upper guide track mounted thereto, in accordance with an aspect of the present disclosure; and

FIG. 25 is a cross section view of the insert and guide track of FIG. 23 mounted to the upper mounting member, in accordance with an aspect of the present disclosure.

### DETAILED DESCRIPTION OF THE INVENTION

In the present specification and claims, the word ‘comprising’ and its derivatives including ‘comprises’ and ‘comprise’ include each of the stated integers but does not exclude the inclusion of one or more further integers.

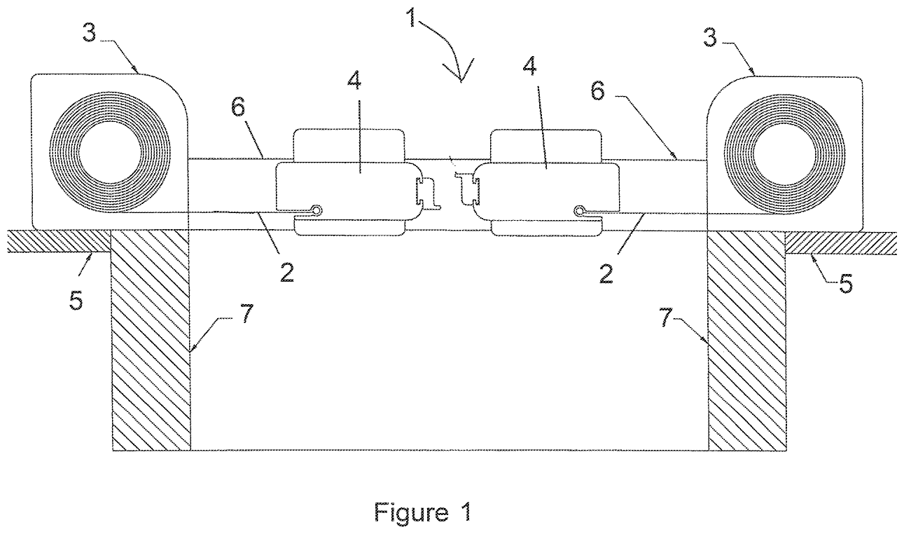

FIG. 1 is schematic top plan view of a prior art retractable screen assembly 1 for use with a double opening external door with opposing door jambs 7 with a sill 8 inbetween. Thus there are two flexible screens 2, each mounted to a retractable roller assembly 3. The flexible screens 2 are each fixed to a handle post 4 to facilitate withdrawing the screen from the roller 3 towards the closed position as shown and controlling withdrawal of the flexible screens into the roller assemblies 2 to the open position

The roller housings 2 are mounted to the external surface of the wall sheet 5 and are thus exposed to view. Similarly, the upper guide track (not shown) is mounted to the exterior of the wall. The lower guide track 6 is mounted to the floor surface, thereby extending into the door space and may cause a trip hazard and/or provide a bar or impediment to wheeled access.

The prior art screen assembly 1 is installed in steps post construction of the building, that is after the wall cladding has been installed. The lower guide track 6 is mounted to the floor, the roller housings 2 are then installed on either side of the doorway space and fixed to the walls. The last step is fixing the top guide track to the wall and installing the flexible screens and handle posts 4.

The present screen assembly allows for a base frame to be constructed as a single unit and fitted directly into a cavity or adjacent an installed door frame during building construction or retrofitting. That is, the base frame is installed first and may be followed by installation of the functional screen components at a later stage. By functional screen components is meant components that allow for the screen assembly to function and includes an upper guide track, lower guide track, roller(s) and roller assembly, flexible screen(s) and handle post(s).

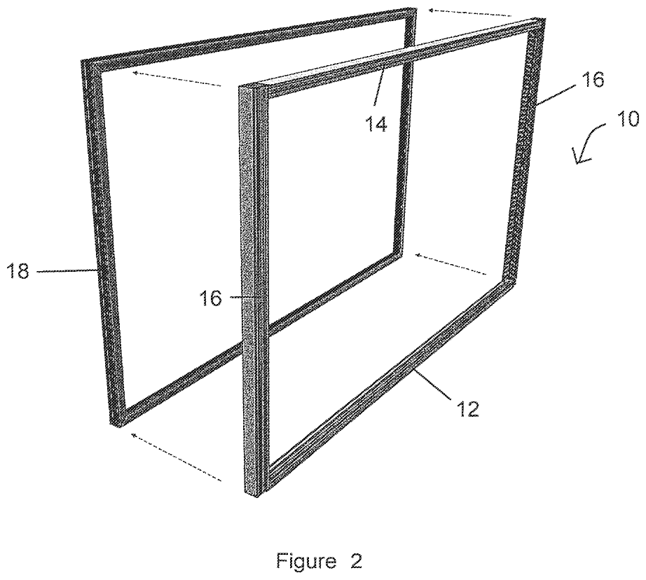

The constructed base frame 10 prior to installation is shown in FIG. 2 and comprises a lower elongate guide track mounting member or sill 12, an upper guide track mounting member or header and 14, and first and second side elongate members or jambs 16.

FIG. 2 also shows the base frame 10 aligned with the frame 18 of a stacker door. In one aspect, the present base frame 10 is installed by mounting and fixing directly to the stacker door frame 20, as will be discussed below.

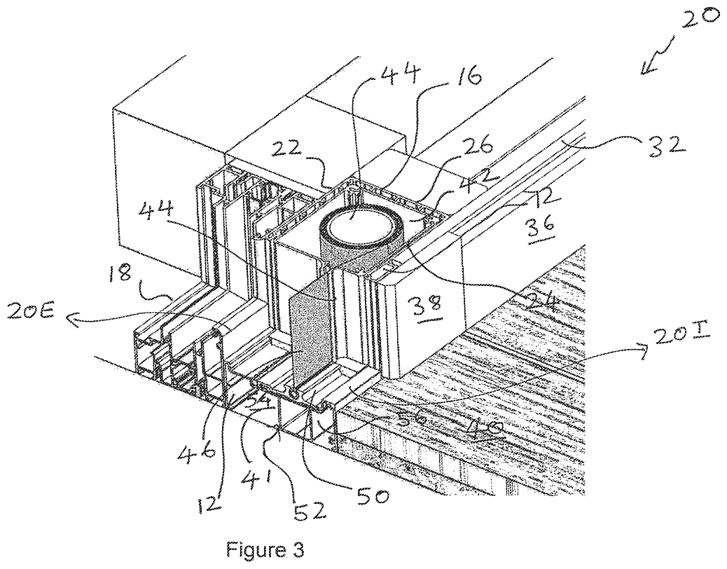

FIG. 3 is a schematic cut away view of the lower corner right side part 20 of a retractable screen assembly as disclosed herein. The screen is installed in an external doorway. Thus the screen assembly 20 has an interior or inner facing side 201 and an external or outer facing side 10E.

The lower left side corner part of the retractable screen assembly is the same as the right side part.

The lower corner part 20 consists of the lower part of the vertical U shaped side elongate member 16 or jamb having two opposed side walls that is an outer wall 22 and an inner wall 24. The walls 22, 24 are joined by a rear web 26.

The jamb 16 is located within a wall cavity 30 that is defined between a layer of interior wall cladding 32 and frame 18. A skirting board 36 and architrave 38 are mounted at the lower part of the internal cladding 32 adjacent the floor covering 40. The floor covering 40 is generally mounted or laid over a concrete slab 41 or other substrate as known in the building art. It may be seen that the wall cladding 32, skirting board 36 and architrave 38 conceal the jamb 16 from view

The frame 18 of the stacker door is located adjacent the exterior side 20E of the screen assembly. The base frame 10 of the screen assembly is fixed to the frame 18 of the stacker door discussed with reference to FIG. 2.

A roller housing 42 and a roller 44 are mounted insider the jamb 16. A flexible insect screen 46 is wound onto the roller 44 and extends through a slot 48 in the roller housing 42.

FIG. 3 also shows the sill 12 with a lower guide track 50 mounted thereon as will be discussed in further detail below. The sill 12 of the screen and is fixed to the lower end of the jamb 16 (the manner of fixing will be described below).

There is an elongate cavity space or recess 52 defined between the edge of the floor covering 40 to one side and the frame 18 of the stacker door to the other side. The base 54 of the cavity space 52 is defined by the concrete slab 41 that supports the floor covering 40.

The sill 12 has a lower U shaped support member 56 or base that extends into the cavity space 52. It will be appreciated that such an arrangement can reduce or minimise trip hazards caused by raised sills of conventional horizontally opening screens that are installed directly onto the floor surface.

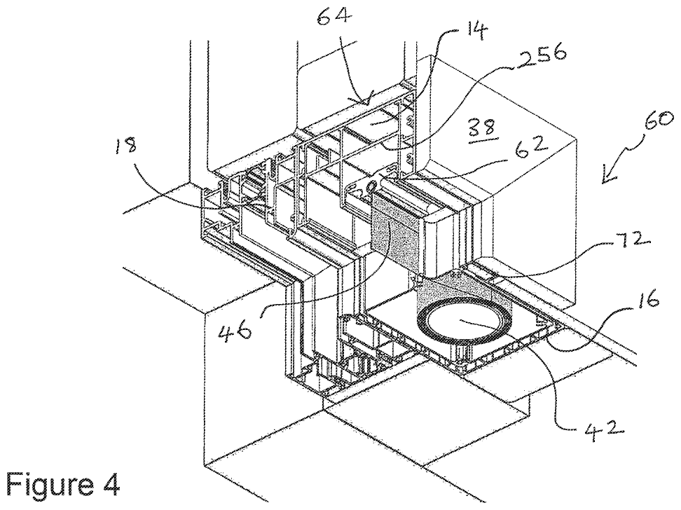

FIG. 4 shows the top right side corner 60 of the screen assembly. The upper part of the jamb 16 is similarly concealed behind the internal cladding 32 and architrave 38.

The header 14 is fixed to the upper end of jamb 16 (the header 14 and manner of fixing will be described further described below). An upper guide track 62 is mounted within header 14 for receiving and guiding the upper end of flexible screen 46.

A cavity space 64 is defined between the horizontal architrave 38 and the frame 18 of the stacker door. The header 14 is received within this space 64.

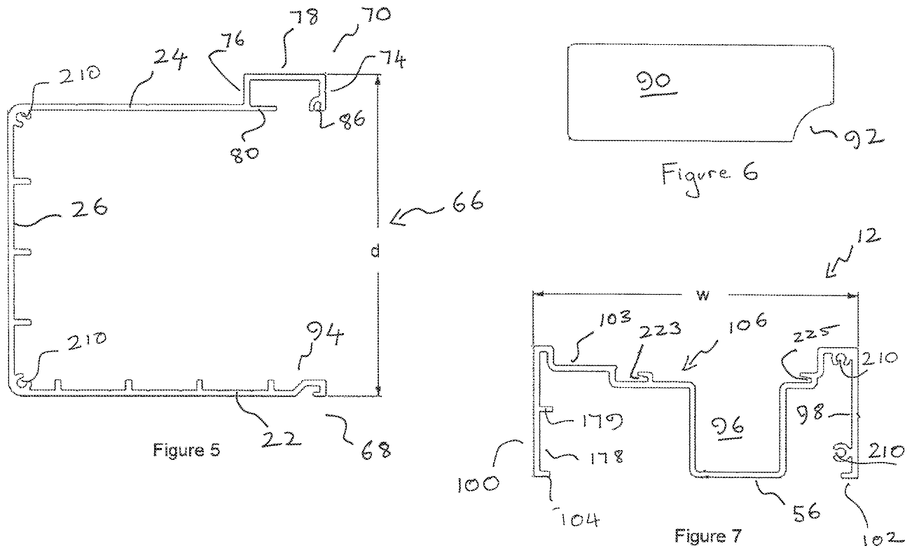

FIG. 5 shows a cross section of the jamb 16. The jamb 16 is an aluminium extrusion. As discussed with reference to FIG. 3, the jamb 16 is U shaped in cross section with an inner facing side wall 24 an outer facing side wall 22 that are joined by a rear web 26. Thus the jamb 16 has an open end 66 opposite the web 26 and the side walls 22, 24 each have a free end 68, 70 at the open end 66.

The free end 70 of the inner wall 24 is configured to form an elongate channel 72 that is substantially rectangular in cross section and projects outwardly from the line of the side wall 24. The channel 72 is defined by a forward transverse side wall 74, a rear transverse side wall 76, an outer longitudinal wall 78 and a partial inner wall 80. An opening 82 is defined between the ends of the partial inner wall 80 and the terminal end 84 of forward side wall 74. The end 84 of side wall 74 is configured to provide a semicircular rib or member 86.

The free end 68 of outer wall 22 is configured to from a cover engagement part 94 (discussed below).

FIG. 6 shows a cross section of an elongate plastics block 90 that has a cross section complimentary to channel 72 such that the block 90 may be slidingly inserted into channel 72 from the end of the jamb 16. The block 90 has a semicircular concave corner profile 92 complimentary to groove 86.

FIG. 7 shows a cross section of sill 12. The sill 12 is also an aluminium extrusion. As discussed with reference to FIG. 3 the sill 12 has a U shaped base support 56 that sits on the floor substrate. The support 56 defines a U shaped channel 96.

The sill 12 also has opposed inner and outer legs or side walls 98, 100 with supporting feet 102, 104 that further support the sill 12.

The sill 12 has an upper mounting portion 106 for receiving the lower guide track 50 as shown in FIG. 3. The support 56 is directly below where the guide track 50 is e mounted so as to provide optimum support.

The distance d between the outer edge of channel 74 and inner wall 24 of the jamb 16 is the same as the width w across the sill 12. Thus, when the jamb 16 and sill 12 are joined together, there is a flush point of connection.

The dimensions of the jamb 16 are limited by the need to be able to house a roller housing. With conventional retractable screens, the dimension of the roller housing is generally much wider than the width of the sill or header (as shown in FIG. 1). Sill 12 therefore includes a spacer rib 103 extending inwardly from the upper end of wall 100.

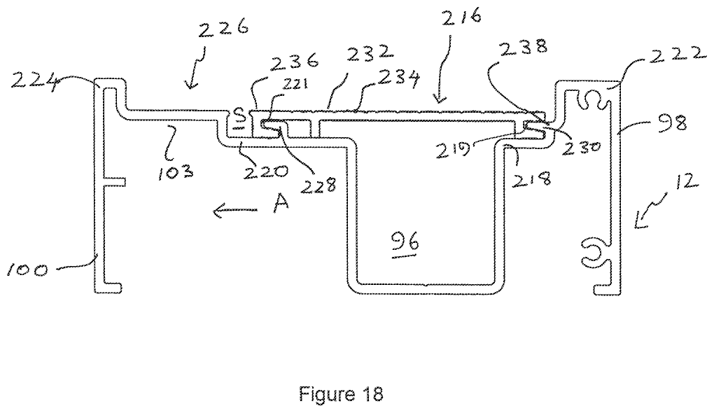

Further details of the sill 12 will be described below with reference to FIG. 18.

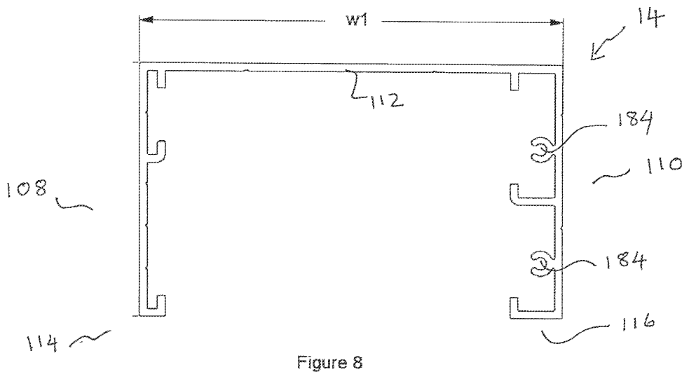

FIG. 8 shows the cross section of the header 14. The header is U shaped with an outer side wall 108, an inner side wall 110 and a connecting web 112.

The width w1 of web 112 is the same as the width w of the sill 12 and distance d of the jamb 16. This allows also for a flush join between the header 14 and jamb 16.

The side walls 108, 110 each have a free end 114,116 that in use form engagement parts for a top guide track assembly, discussed below.

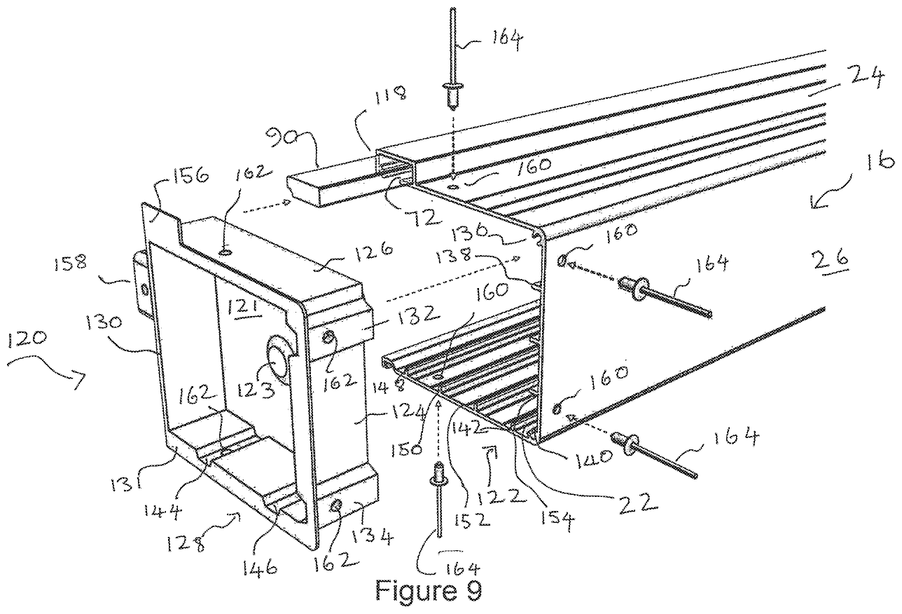

FIG. 9 shows the first steps in the assembly of the base frame 50 that begins with the side members or jambs 16. FIG. 9 shows that the block 90 that is shown in FIG. 6 is inserted into the end 118 of channel 72. As discussed below, the channel 72 and block 90 will receive screws to fasten to other base frame members. The plastics material of the block 90 allows additional purchase of the screws so as to provide a more robust construction.

Further, referring back to FIGS. 3 and 4 it may be seen that the channel 72 is a similar width to the wall cladding so as to provide a convenient spacing for installation of the wall cladding. The channel 72 further provides a stop for the cladding 32.

The next step is to provide an end cap 120 and insert the end cap 120 into the lower end 122 of the jamb 16.

The end cap 120 is formed from a moulded thermoplastics material.

The end cap 120 is substantially square in plan view and U shaped in cross section so as to define a cavity with a base 121 that inserts into the end of the jamb 16. The base 121 has a central circular recess 123 or receiving an end of a roller.

The end cap 120 has four side walls, a rear side wall 124 (in use facing inward towards the wall cavity or wall and is adjacent the web 26 of the jamb), an inner side wall 126 that in use is adjacent inner wall 24 of jamb, an outer side wall 128 that in use is adjacent outer side wall 22 of jamb 16 and a front side wall 130 (in use facing away from the wall cavity or wall towards the doorway).

The end cap 120 has a flange 131 extending about walls 124, 126, 128. The flange 131 serves as a stop against walls 22, 24, 26 of the jamb 16 when the end cap 120 is inserted into the end of the jamb 16.

The rear wall 124 of the end cap 120 has two spaced apart locating members 132, 134 in the form of longitudinal ribs or projections extending from the wall 124. The members 132, 134 are configured to be slidingly and snugly received between one corner 136 of jamb 16 and inward facing rib 138 and the other corner 140 of jamb 16 and inward facing rib 142 respectively.

Similar locating members 144, 146 are located on outer side wall 128 for locating between ribs 148, 150 and 152,154 respectively on inner side wall 24 of the jamb 16. It will be appreciated that this allows for easy alignment of the end cap 120 with jamb 16.

Inner wall 126 does not have any locating members and is substantially flat and complementary to the inner surface of outer wall 22 of the jamb 16. Inner wall 126 has a rectangular tab 156 extending therefrom. The tab 156 is dimensioned such that when the end cap 120 is inserted into the end of the jamb 16, the tab 156 extends and closes over the channel 72 of the jamb 16, thereby retaining the plastics block 90 therein.

The front wall 130 of the end cap 120 has a U shaped locating tab 158 extending therefrom that is used to cooperate with the sill 12 as discussed below.

The jamb 16 has a single predrilled hole 160 in each of the outer wall 22 and the inner wall 24. There are also two predrilled holes 160 in the rear web 26.

The end cap 120 has an aperture or through hole 162 formed through the locating member 144 in the outer wall 128, an aperture 162 in each of the locating members 132, 134 on the rear wall 124 and in inner wall 126. The respective pre-drilled holes 160 and apertures 162 are configured such that when the end cap 120 is in place within the lower end 122 of the jamb 16, the holes 160 and apertures 162 align. This allows the end cap 120 to be fixed to the jamb 16 by rivets 164.

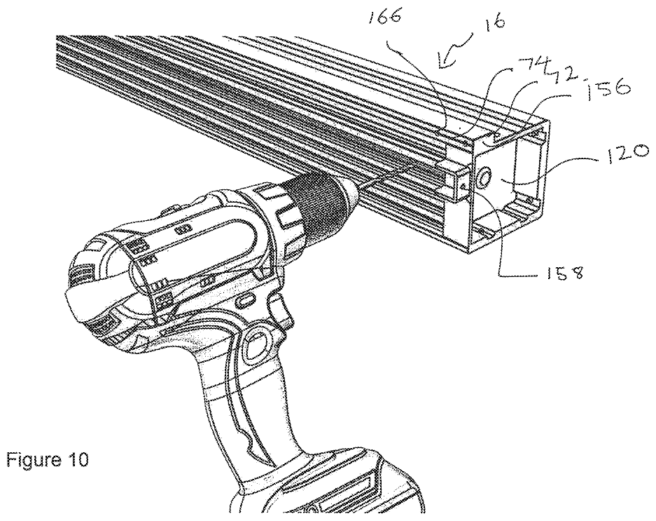

FIG. 10 shows the next step in which two measured and spaced holes 166 are drilled through the forward side wall 74 of channel 72 through the enclosed block 90 and through to the rear side wall 76.

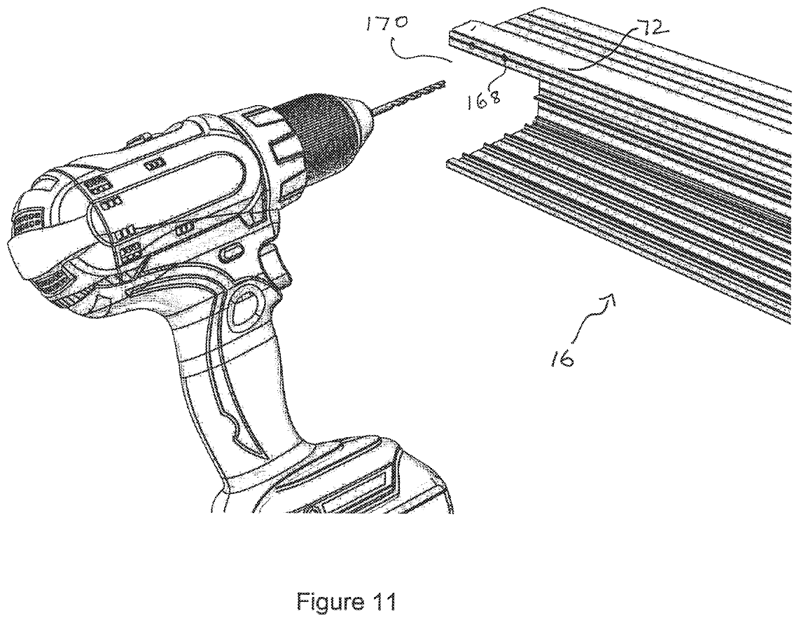

FIG. 11 shows similar holes 168 drilled into the upper end 170 of the jamb 16 and through the jamb channel 72 and block 90.

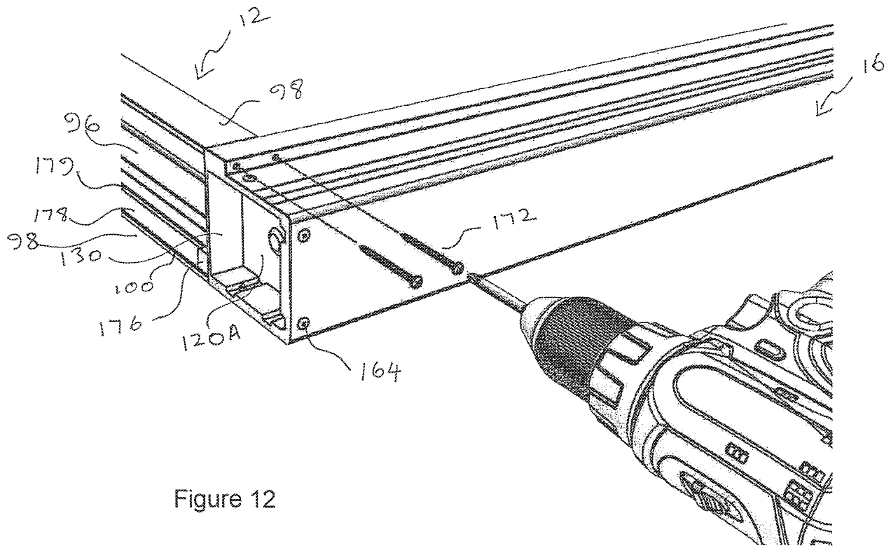

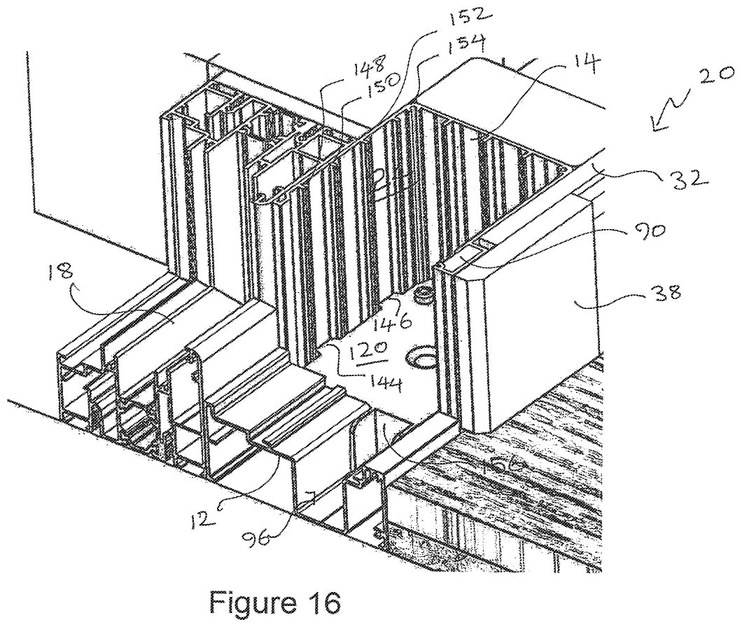

FIG. 12 shows the sill 12 being attached to the jamb 16. The sill 12 is pushed up tightly against the bottom of jamb 16 so that the tab 158 is received in channel 96 of sill 24. (This may be more easily seen in FIG. 16). In this way, the sill 12 is accurately located or positioned with respect to the jamb 16.

The sill 12 is then attached to jamb 16 by use of screws 172 through the holes 166 made as described previously. The screws 172 pass through the plastics block 90 and are received in the screw grooves 174 on the sill 12 (see FIG. 7).

The end cap 120A of FIG. 12 differs from that shown in FIG. 10 in that is has an additional tab 176 extending transversally from front wall 130 of end cap 120. The tab 176 is rectangular in cross section and is dimensioned to be snugly received in an inwardly facing channel 178 of the sill 12 that is defined between the inwardly extending foot 98 of wall 100 and the inwardly extending rib 179. This provides for a further point of locating and attachment by fixing the sill 12 to the jamb 16.

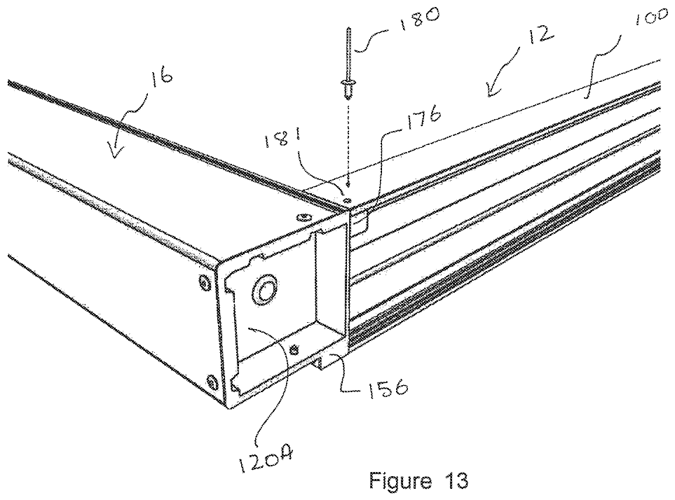

FIG. 13 shows that the sill 12 has a predrilled hole 181 in wall 100 and that tab 178 is secured to the sill 12 by a rivet 180 through the wall of the sill 12.

These attachment steps are repeated on the opposite side of the sill 12 with the second jamb 16.

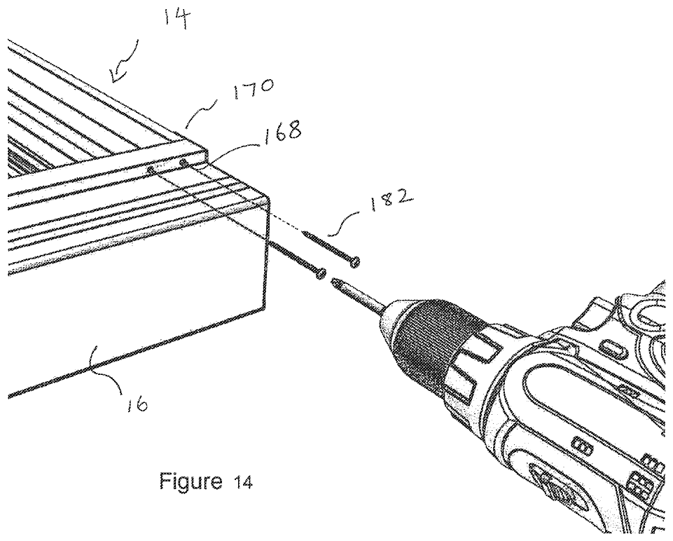

FIG. 14 shows the frame header 14 being secured to the upper part 170 of the jamb 16 by means of screws 182 through the holes 168 drilled in the previous step as shown in FIG. 11. The screws 182 are received in screw grooves 184 on the inwardly facing side of outer side wall 110 of header 14 (shown in FIG. 8).

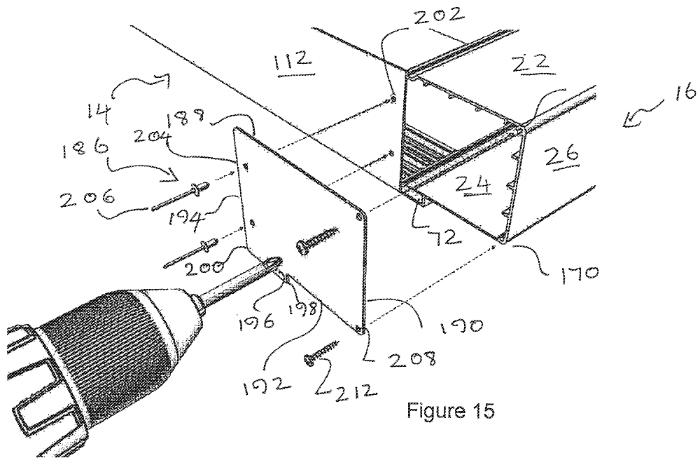

FIG. 15 shows the final step of the base frame 10 assembly in which the top end of each jamb 16 further is secured to the header 14 by means of an upper corner cap 18. Cap 186 is substantially rectangular with four side edges. The side edges will be referenced in relation to their location when installed. Accordingly there is an outer side edge 188 that abuts outer wall 22 of jamb 16, rear side edge 190 adjacent web 26 of jamb 16, inner side edge 192 adjacent inner wall 24 of jamb and forward side edge 194 overlapping web 112 of header 14 and open end 66 of jamb 16.

The cap 186 is dimensioned to seal the open end of jamb 16, that is the edges of the cap 186 overlap the upper edges of the jamb but do not overextend the jamb 16 so as to present a flush finish.

The cap 186 has a rectangular tab 196 extending from inner side edge 192. The tab 196 has a first end part 198 remote from the forward side edge 194 and a second end part 200 flush against forward side edge 194.

The first end part 198 locates and seals against channel 72 so as to retain the block 90 therein. The second end part 200 extends across and abuts the web 112 of the header 14.

The web 112 of the header 14 has two spaced predrilled holes 202. The cap 186 has two spaced apertures 204 along the forward edge 194 that align with holes 202. Thus the cap 186 may be fixed to the jamb 16 by rivets 206.

The cap 186 also has two holes 208 along the rear r side edge 190. These holes 208 align with screw grooves 210 on jamb 16 (see FIG. 5) so that the cap 186 may be fixed to the jamb by screws 212.

It may be appreciated that such an overlapping arrangement of the cap 186 with respect to the jamb 16 and the header 14 allows for both connection and alignment of the jamb 16 and header 14.

The base frame 10 is now ready for installation. The base frame 10 may be installed during construction by fixing to an installed door frame 18, installed directly into a cavity or retrofitted after completion of construction. Alternatively, the base frame 10 may be fixed to the door frame 18 and the two frames may then be installed as a single unit.

When the base frame 10 is to be installed during construction, the installation of the base frame 10 is carried out before the walls are cladded and finished with architraves and skirting boards. This allows an integrated and sealed finish.

It may therefore be some time before the functional members of the final screen assembly are installed. The functional members being the upper and lower guide tracks, roller assembly and flexible screen. In some cases, the base frame may be installed during construction to provide a buyer with the option of installing a retractable screen at a later date.

In this case, it may be desirable to provide covers for the sill and jamb so as to protect the cavities therein from collecting construction debris that will have to be thoroughly cleaned prior to installing the screen.

FIG. 16 is a similar view to FIG. 3 in that it shows the bottom corner 20 of an installed base and after the wall cladding 32, skirting board 36 and architraves 38 have been fitted but before the lower guide track and roller housing have been installed. It may be seen that the inside of the jamb 16 and the open channel part that defines the channel 96 of the sill 12 are exposed.

FIG. 16 also shows the arrangement of the end cap 120 within the jamb 16 and the how tab 156 fits into channel 96 of the sill 12. FIG. 16 also shows how the locating members 144, 146 fit between respective vertical pairs of ribs 148, 150 and 152, 154 on outer wall 22 the jamb 16.

The channel 96 is open to the interior of the room and may form a tripping hazard as well as accumulating dirt and debris. Likewise the interior space of the jamb 16 is open to the interior space of the room. The open channels are also unsightly.

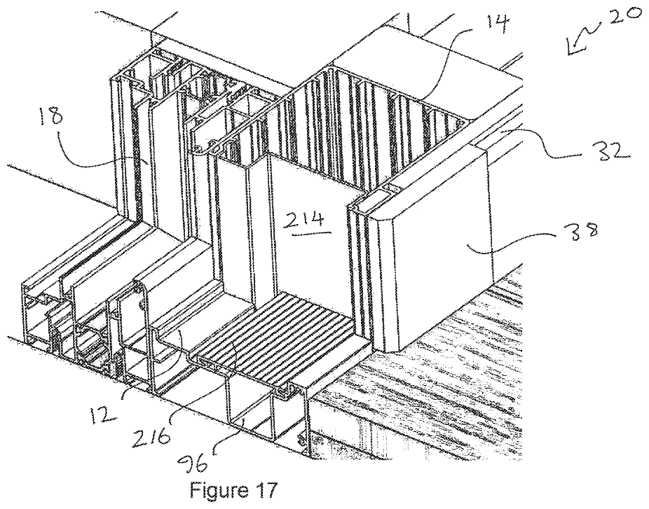

FIG. 17 shows the same bottom corner view 20 as shown in FIG. 16 except that a cover member 214 seals against the opening of the jamb 16 and a cover member 216 seals across the sill 12. It will be appreciated that apart from protection from ingress of construction debris and a trip hazard, the covers may provide an integrated look and will blend in with the door frame.

FIG. 18 shows a cross section of the sill 12 and cover 216 engaged together. The sill 12 includes horizontal support arm members 218, 220 extending to either side of channel 96 towards legs 98, 100. The support arms 218, 220 are below the uppermost level 222, 224 of the legs 98, 100. There is a stepped section 226 between support arm 220 and the top 224 of wall 100. The stepped section 226 includes the spacer part 103.

Each support arm member 218, 220 has an upstanding cover engagement part 228, 230 in the form of an inverted L shape with a vertical section and a horizontal section that defines a horizontally opening channel 223, 22k between the horizontal section and the support arms 218, 220. The opening of each channel faces towards side wall 100 and away from inner wall 98.

The sill cover 216 has a planar upper cover part 232 (with corrugations 234 for anti-slip) and two side edges 236, 238. Each side edge 236, 238, terminates in a sill engagement part complimentary to engagement members 228, 230 on the sill 12. That is each sill engagement part has an L shaped profile with a horizontal section a vertical section depending from top part 216 defining a U shaped channel 221, 223 (more clearly shown in FIG. 8). Each channel opening faces towards inner wall 98 away from outer wall 100.

FIG. 18 shows the sill 12 and the cover 261 in the engaged position. The edges 236, 238 of the cover 216 interlock with the upstanding engagement parts 228, 230. A space S is defined between stepped portion 226 and upstanding member 228. This allows for sideways sliding movement of the cover 216 towards outer wall 100 in the direction of arrow A so as to disengage the engagement parts and allow the cover 216 to be removed from the sill 12. The sill 12 and cover 216 may be

In order to prevent inadvertent movement or disengagement of the sill 12 and cover 216, a stop suitably in the form of a flexible, resilient retaining strip is placed in space S.

When it is desired to remove cover 216 and replace it with a lower guide track for the retractable screen, the retaining strip is removed and the cover moved sideways and removed.

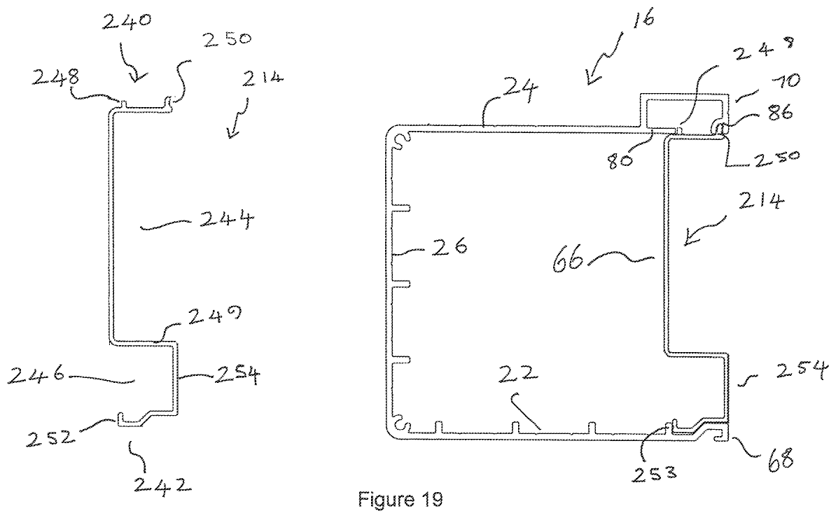

FIG. 19 shows a cross section of the jamb 12 and cover 214 therefore. The cover 214 has a profile comprising two oppositely opening U channels, a major channel 244 opening that when fitted opens away from the jamb and a minor channel 246 opening towards the jamb 16. The cover 214 has a first inwardly facing side wall 240, an outwardly facing side wall 242 and an intermediate wall 249 separating the channels 244, 246.

The cover 14 fits across the open side 66 of jamb 16. The major channel 244 is recessed within the jamb 16 and side wall 240 of the cover 214 terminates in a projecting curved rib 250 for snap fitting engagement with groove 86 of the jamb 16. The other channel end of the side wall 240 abuts the free end of wall 80. The side wall 240 also has an outwardly projecting rib 248 towards the channel end that serves as a stop against the end of wall 80.

The web 254 of the minor channel 246 aligns with the free ends 70, 68 of the side walls 24, 22 of the jamb 16. The inner side wall 240 of the cover 214 terminates in a projecting curved rib 250 for snap fitting engagement with groove 86 of the jamb 16. Side wall 240 also has an outstanding rib 254 that serves as a stop

The base end of wall 244 abuts end 80 of wall 24 of the jamb 16.

The side wall 242 has a free end portion that turns back on itself to define a return part 252. The return part 252 is complimentary to engagement part 94 of wall 22 pf the jamb to allow for engagement therewith.

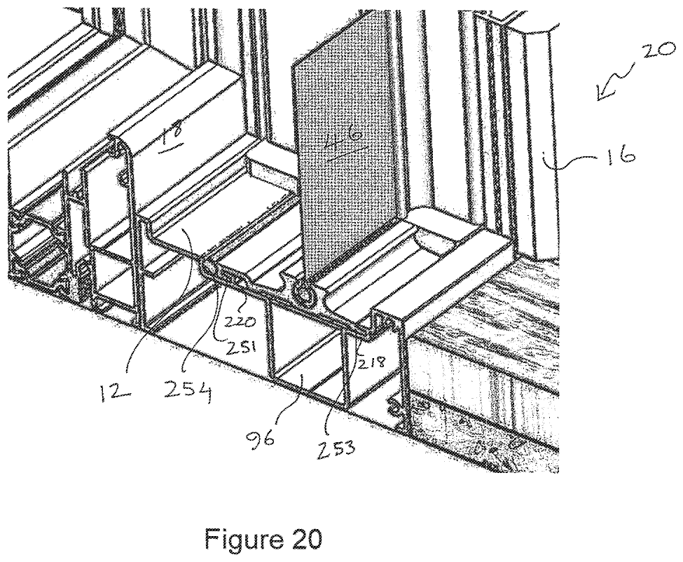

FIG. 20 is a detail of FIG. 3 showing how the lower guide track 50 engages the sill 12. It will be seen that the engagement is similar or the same to that of the cover 216. Specifically, the side edges 251, 253 of the lower guide track 50 have parts that are received within recess 223, 225 in the sill 12.

The relative positon of the guide track 50 is also sealed by a retaining strip in the form of a silicone strip 254.

FIG. 20 also shows how the spacer part 103 spaces the guide track 50 from the frame 18.

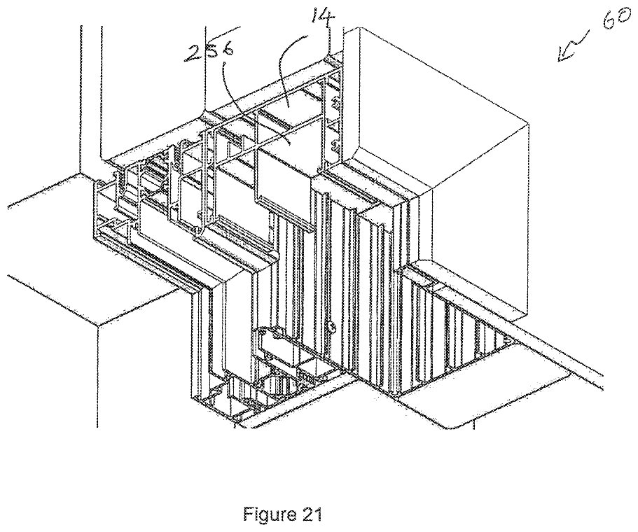

FIG. 21 shows the upper corner 60 of the assembly that is shown in FIG. 4 but without the cover on the jamb 16 or any functional members of the screen. FIG. 20 also shows a header insert member 256 mounted within header 14. The insert member 256 allows the upper guide tack 62 to be mounted to the base frame 10 after installation.

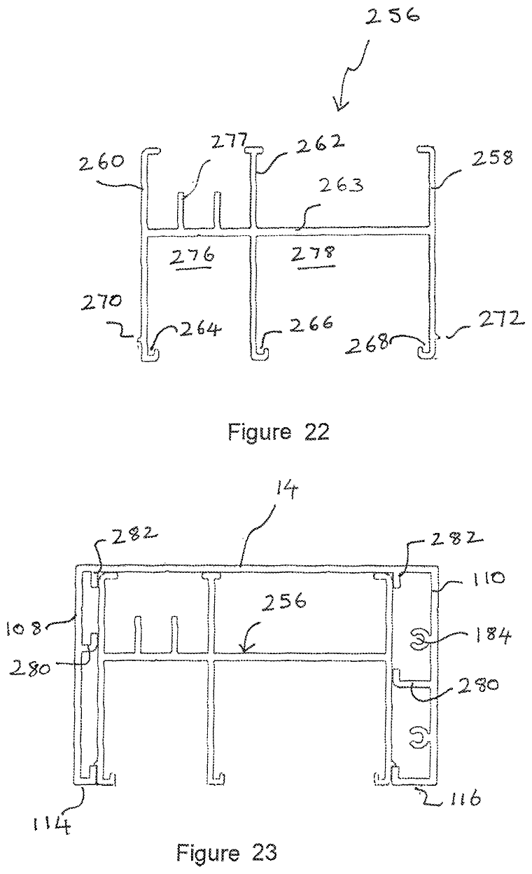

FIG. 22 shows a cross section view of the insert member 256 and FIG. 23 is a cross section view of the header 14 and insert 256 engaged or mounted together.

The insert member 256 has opposing outer side walls 258, 260 and an intermediate vertical wall 262 connected by a cross member 220.

The lower part of each wall 258, 260, 262 is a J shaped in cross section so as to define a longitudinal recess 264, 266, 268. The lower part of the outer walls 258, 260 also has a downward facing barb shaped rib 270, 272 on the outer facing side thereof.

FIG. 23 shows how the insert 256 and header 14 engage. In practice, the insert 256 can be inserted upwardly into the header 14 so as to interlock the two parts by a snap fit as barbs 270, 272 snap over the J shaped ends of the walls 108, 110 of the header 14. There are also longitudinal spacer ribs 280, 282 extending inwards from the walls and web of the header 14 for providing support for the outer walls of the insert. Further support is provided by the T shaped upper section of intermediate wall 262 of the insert 256.

The walls of the insert 256 below the cross arm 264 defines two downward facing channels 232, 234 between the respective walls below the cross member 220. The larger channel 234 receives a guide track 300 for the flexible screen as described with reference to FIG. 25 below.

The smaller channel 232 serves as a spacer such that the width of the header 14 matches the width of the jamb 16. The spacer has longitudinal reinforcing ribs 231.

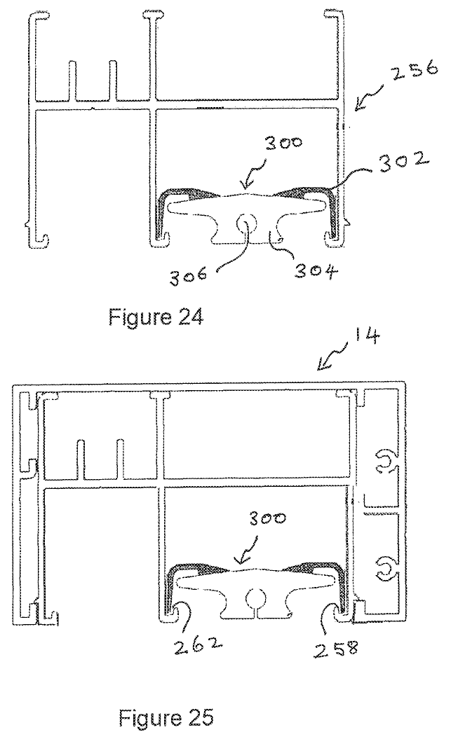

FIG. 24 shows cross section same arrangement of insert 256 with an upper guide track 250 mounted thereto. The guide track 300 is similar that described in AU20172684647 that is incorporated herein by reference. The guide track 300 has a main body part 304 with resilient wings 302 extending from either side 252 of the body 306. The body has a central hole with a slot opening to the exterior of the body for retaining an upper edge of a flexible screen that has a thickened or zipper edge as known in the art. The resilient wings 302 are biased towards an open position and are compressed against the bias between the walls 262, 258 of channel 278. The ends of the wings 352 are retained within the channel by the J shaped ends of the walls 262, 258. The bias of the wings 352 can compensate for any movement of the frame 10 that may occur over time due to earth subsidence or the like. This may be a particular problem with flexible screens that span large distance, up to 9 or 12 meters or so.

It will be appreciated that in view of the outward bias of the wings ad wings into a channel as the wings must be outwardly biased so as to be self supporting within the channel. AU 20172384347 addresses this by providing a two part header that is first connected loosely, the guide track is inserted with the wings in the in the open position and then the two parts are gradually brought together to move the wings towards the guide body in the biased position.

In the present assembly, the guide track that is in the form of an elongate strip is slidably inserted into channel such that the wings do not need to be pressed upwardly through the narrow width between the ends of the J shaped retainers. It will be appreciated that such slidable insertion is impossible for a pre-installed base frame.

When the guide track is inserted into the insert, it is a simple matter to clip the insert into place when required without the need to install the header onto the wall in multiple parts.

The snap fit insertion of an insert according to the present invention is not limited to a guide track with resilient wings and may equally be used with any guide track suitable for use with a flexible screen. As discussed above, many guide tracks are configured to be screwed direly to pre-existing door frame. Such guide tracks cannot be installed prior to wall cladding. However, if such guide tracks are reconfigured for slidable insertion into an insert as described herein they may readily be mounted to a base frame after installation of the base frame.

The invention has been described in language more or less specific to structural features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art. As may be recognized by those of ordinary skill in the art based on the teachings herein, numerous changes and modifications may be made to the above-described and other embodiments of the present disclosure without departing from the scope of the disclosure. The components of the implants as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. An assembled base frame for mounting to a support, the base frame comprising;
a lower elongate member having an upper mounting part;
an upper elongate member and two side elongate members each having an upper part and a lower part respectively fixed to the upper and lower elongate members, wherein;
the upper mounting part of the lower elongate member is configured for engaging a lower guide track of a retractable screen when the base frame is mounted to the support,
the upper elongate member is configured to receive an upper elongate guide track of a retractable screen when the base frame is mounted to the support and one or both of the side elongate members are configured to receive a roller housing for a retractable screen.

2. The base frame claim 1, wherein the upper elongate member has a U shaped profile with opposing side walls, each wall having inwardly extending engagement members for engagement with an upper guide track.

3. The base frame of claim 2, wherein each side elongate member is an aluminium extrusion having a U shaped profile with a first side wall, a second side wall a web and an open side, such that each side wall has a free end remote from the web the free end of the one wall terminates in a rectangular channel and a longitudinal plastics block is received within the rectangular channel.

4. The base frame of claim 3, wherein the lower elongate member has a first side wall and a second side wall and the lower elongate member is fixed to a lower end of each side elongate member such that the first side wall is transvers to the rectangular channel of the elongate side member and at least one fastener extends through the rectangular channel and the plastics block contained therein and into the end of the first side wall of the lower elongate member.

5. The base frame of claim 4, further comprising an end cap received within the lower end of each side elongate member, the end cap having a first side wall adjacent the first side wall of the side elongate member, a second side wall adjacent the second side wall of the side elongate member, a rear wall adjacent the web of the side elongate member and a front wall across the open side of the side elongate member

6. The base frame of claim 5, wherein the end cap comprises a tab extending from the front wall that seals the end of the rectangular channel.

7. The base frame of claim 6, wherein the inner surface of one or both side walls of the side elongate member includes at least two longitudinal ribs and the one or both side walls of the end cap comprise at least one locating projection dimensioned to be received between two of the at least two longitudinal ribs.

8. The base frame of claim 7, wherein the end cap is fastened to the side elongate member by at least one fastener passing through the or each wall and through the at least one locating projection.

9. The base frame of claim 8, wherein the at least one faster is a permanent fastener.

10. The base frame of claim 9, wherein the end cap further comprises a tab extending from the front wall and the tab is dimensioned to locate within the U channel of the lower elongate member.

11. The base frame of claim 10, wherein the lower elongate member is an aluminium extrusion that has a lower base part configured to be received in a recessed floor cavity.

12. The base frame of claim 11, wherein the lower elongate member has a profile in which the lower base part includes a U channel section extending below the upper mounting part and in use the web of the U channel rests on the base of the recessed floor cavity.

13. The base frame of claim 12, wherein the upper mounting part comprises a first horizontal support arm extending away from one side of the U channel, a second horizontal support arm extending away from the other side of the U channel and each support arm member has a guide track engagement part.

14. An assembly comprising the base frame of claim 1 mounted to a support that is a frame for a sliding door, a bi-fold door or a stacker door.

15. The assembly of claim 14, wherein the base frame comprises a cover removeably mounted to the upper mounting part of the lower elongate member and a cover removeably mounted to each side elongate member.

16. A retractable screen comprising the base frame of claim 1, a roller assembly mounted in one or each side elongate member, an upper guide track mounted to upper mounting member and a lower guide track mounted to the lower mounting member, wherein the upper guide track is in the form of an upper guide track assembly comprising a guide track housing and an upper guide member mounted thereto, whereby the track housing is configured for mounting to the upper elongate mounting member.

17. The retractable screen of claim 16, wherein the upper elongate member has a U shaped profile and the guide track housing is configured as an elongate insert member for inserting into the U shaped upper elongate member and the elongate insert member comprises a first side wall, a second side wall and an intermediate wall each connected by a cross member so as to define a first downward opening U channel between the first side wall and the intermediate wall and a second downward opening U channel defined between the second side wall and the intermediate wall and the upper guide track member is located within the first channel.

18. The retractable screen of claim 17, wherein the side of walls of the upper elongate member and the outer side of the walls of the elongate insert member are configured for snap fit engagement when the elongate insert member is inserted into the U channel of the upper elongate member.

19. The retractable screen of claim 18, wherein an elongate guide track is mounted within the first channel by slidable insertion into the channel and the elongate guide track comprises an elongate body having a lower face with a longitudinal channel for receiving and retaining an upper edge of a retractable screen; a first substantially resilient wing and a second substantially resilient wing extending from respective first and second sides of the elongate body and each first and second wing comprises a proximal end towards the elongate body and a distal end and each wing is biased towards an open position in which the distal end of each wing is away from the body and is moveable against the bias to a retracted position in which each distal end of each first and second wing is towards the body.

20. A method of installing a retractable screen assembly, comprising providing the base frame of claim 1, mounting the base frame to a support and after the base frame has been mounted to the support, the steps of, in any order, mounting an upper guide track to the upper elongate member, mounting a lower guide track to the lower elongate member and mounting a retractable screen roller assembly to one or both of the side elongate members, wherein the support and base frame are mounted within an internal wall cavity and wall covering is installed over the base frame and prior to the mounting of the upper guide track, the lower guide track.
